(19) United States
(12) Patent Application Publication
(10) Pub. No.: US 2023/0243546 A1
(43) Pub. Date: Aug. 3, 2023

(54) Energy Recovery Device and Air Conditioning System Support Base

(71) Applicant: Stephen Gerard Ehrman, Indianapolis, IN (US)

(72) Inventor: Stephen Gerard Ehrman, Indianapolis, IN (US)

(21) Appl. No.: 17/588,230

(22) Filed: Jan. 29, 2022

(51) Int. Cl. F24F 12/00

(52) U.S. Cl. CPC F24F 12/001

(57) ABSTRACT

An energy recovery system used in an Air-Conditioning system (HVAC) that also serves as a supporting base structure. Commonly used with mass produced residential or light commercial manufactured air conditioning systems where air handling units are located indoors. The arrangement includes core or wheel type energy recovery media arranged and affixed within a support base in an orientation and method to maximize the amount of energy recovery surface area installed in a minimum area while still allowing good airflow practices. Other items included may be filter racks preceding where air enters the energy recovery cores, a singular or multiple fan(s) to move the air, a condensate drain pan, shut off and bypass dampers, defrost components and sensors. A direct digital controller may also be included to maximize efficiency and control.

### CROSS-REFERENCE TO RELATED APPLICATIONS

U.S. Non Provisional application Ser. Nos.: 17/098,397; 17/346,264

### STATEMENT REGARDING FEDERALLY SPONSORED RESEARCH OR DEVELOPMENT

None

### REFERENCE TO SEQUENCE LISTING, A TABLE, MICROFICHE OR A COMPUTER PROGRAM LISTING COMPACT DISK APPENDIX

None

### BACKGROUND OF INVENTION

### Field of the Invention:

The present invention is within the technical field of heating, ventilating and air conditioning systems (HVAC). More particularly, the invention pertains to ventilating spaces using outside air and pretreating the outside air with energy recovery ventilators (ERVs).

### Description of the Related Art

Introducing outside ventilation air into residences, buildings and indoor spaces thru the air conditioning system provides many benefits, including increasingly recognized health benefits to humans such as greater cognitive effect for clearer thinking, mitigating spread of virus, disease, and diluting cancer-causing carcinogens in the spaces. Further, when applied correctly, ERVs can save precious energy due to a more efficient total system operation. There exist devices commonly called energy recovery ventilators (ERVs) that are available to be attached onto traditional heating, ventilating and air conditioning systems (HVAC). However, attaching and installing energy recovery devices becomes difficult and time consuming, even though doing so provides many desirable benefits. The cause of difficulty is because the ERV is space consuming, requires a meticulous task of attaching ductwork to a HVAC systems' return and supply air connections and similarly attaching ductwork to outside air intake and outside air exhaust terminations, and routing this ductwork thru the space where the main HVAC components are located. Compounding the difficulty of installation is that when the air-handling components of an HVAC system are indoors, surrounding space is limited and access is difficult. The current offerings and design of an ERV is approximately a square cube or rectangular cube made to contain energy recovery media and other accessories such as fans, dampers, and filters. Although, these units have been refined in type, dimensions, and attachments over the years to ease installation, the design has not evolved nor changed significantly over the recent several years. Therefore, given the complexity of applying the existing ERV offerings, and the recognized immense health benefits to inhabitants, there exists a need to provide energy recovery ventilation in a device that is cost effective, easy to install, serves additional purposes of housing auxiliary devices and components that make the ERV state of the art, all while becoming a support base structure for an HVAC system. These features all provide ease of maintenance of the entire system, as well as increasing system functionally efficiency. The present invention provides the non-obvious ability to provide all this as detailed in the summary and descriptions of the invention below.

### SUMMARY OF INVENTION

### Brief Summary of the Invention

The present invention provides the advantages incorporating desirable energy recovery into a supporting base for the indoor air handling unit typically associated with an HVAC system. The invention also provides refined and optimized cabinet size, and newest technology of fans and electrical devices including energy optimizing wi-fi communication. Indoor air handling units are usually seen in residential, multi-family, light commercial, or the like, type of installations. The primary advantage of this invention is ease of installation, but secondarily the invention necessarily raises the height of the typical HVAC components and additionally provides for incorporating an easy and sturdy leveling system for the entire assembly. The subject invention solves many of the problems with the existing art including the main issue of otherwise requiring a wall, ceiling, or free ductwork location to mount the separate ERV where space is not always available. The subject invention also provides simple electrical hook up and control interface, and reduced duct connections and routing, all while providing and enhancing the benefits associated with existing ERV designs. Additionally, because vertical height above the air handling unit is typically wasted, and filler pieces of ductwork are then required to be installed to transition from the air handler to the main duct, raising the height of the HVAC system by placing it on top the present invention ERV, lessens or negates, said otherwise wasted ductwork transition. Still further, lifting the HVAC system air handler off the floor and placing it on top of the present invention ERV makes servicing all the major components of the HVAC system easier, and provides a solid base to level the main components.

### BRIEF DESCRIPTION OF THE DRAWINGS

FIG. 1 is a perspective view of the present invention used in an application showing the main components of a system.

FIG. 2 is a perspective view of the present invention looking down from the front side and top.

FIG. 3 is a perspective plan view of the present invention showing the main components.

FIG. 4 is a perspective plan view of the present invention showing the main components in an alternate arrangement than that of preferred embodiments.

FIG. 5 is a perspective plan view of the present invention showing the main components in a different shape than preferred embodiments.

FIG. 6 is a diagrammatical representation of the invention's preferred electronics control system.

### DETAILED DESCRIPTION OF THE INVENTION

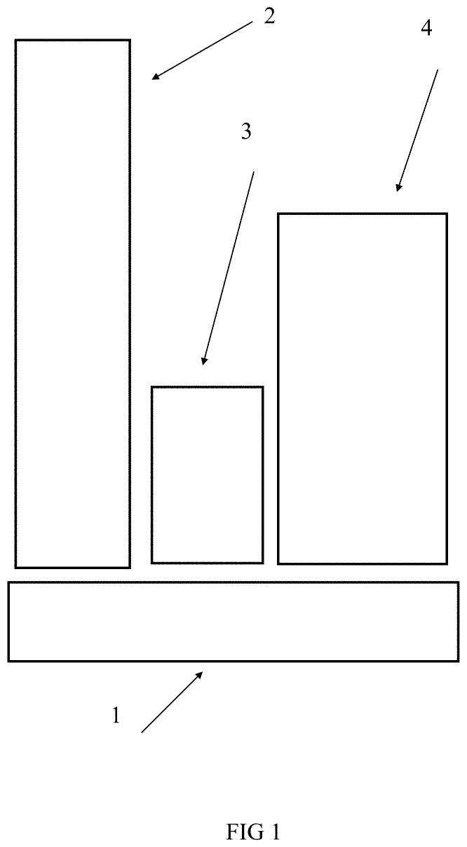

Referring now to the invention in more detail, FIG. 1 shows the present invention 1 with preferred embodiments situated within typical components of a simple Heating Ventilating and Air Conditioning (HVAC) system. The typical components are depicted as the return ductwork 2, an interconnecting duct 3 sometimes also being a filter housing and 4, an air handler or furnace-fan coil or the like.

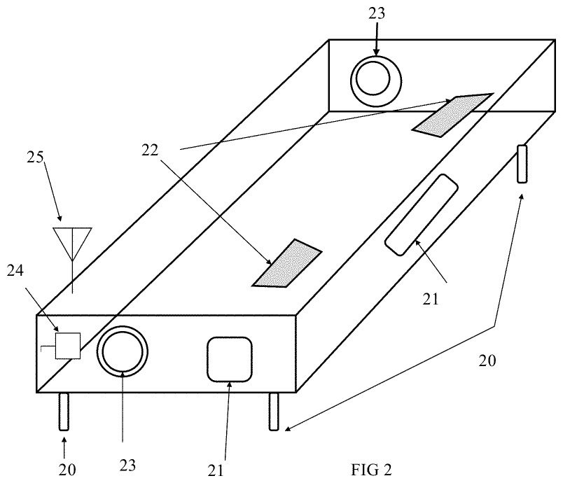

FIG. 2 shows the present invention in more detail depicting a view of the exterior outer casing with vertically adjustable leg supports and level devices 20. The outer casing shown has access door(s) 21 to service the internal devices. The top of the enclosure has openings air paths 22 which can be interchangeable of either supply or return air depending on orientation and preference. The assembly cabinet shown include external duct connections 23 where outside air flows into, and additionally stale exhaust air flows out of, the invention. The casing may have an electrical disconnect switch 24 and may include an antenna 25 for wi-fi, Bluetooth or other RF wireless communication to a controller, detailed in later drawings.

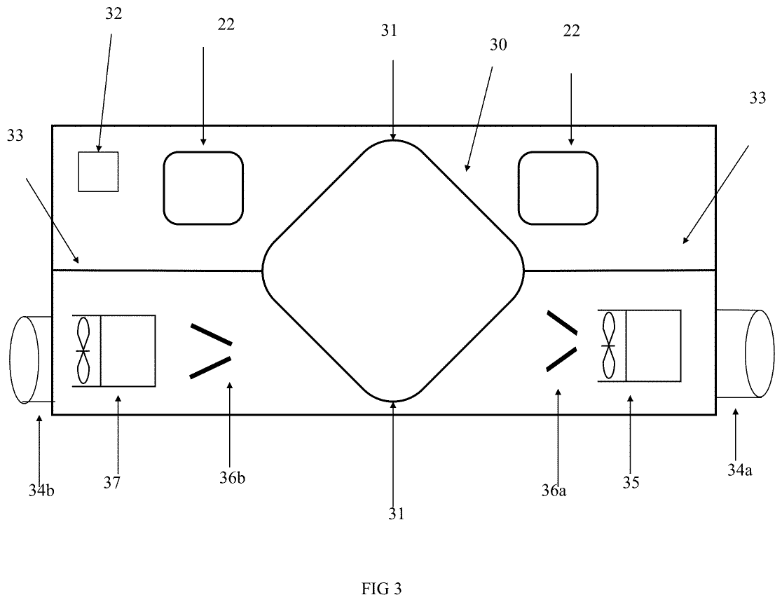

FIG. 3 contains component details, showing the air openings 22, an energy recovery core 30 affixed to side of cabinet in location 31. The invention contains a controller 32. Airflows are separated with a divider 33. External airflow connections 34a & b stub out from side of unit. The invention may have internal fans 35 and 37 sized for separate operating parameters, and isolation air dampers 36a & b.

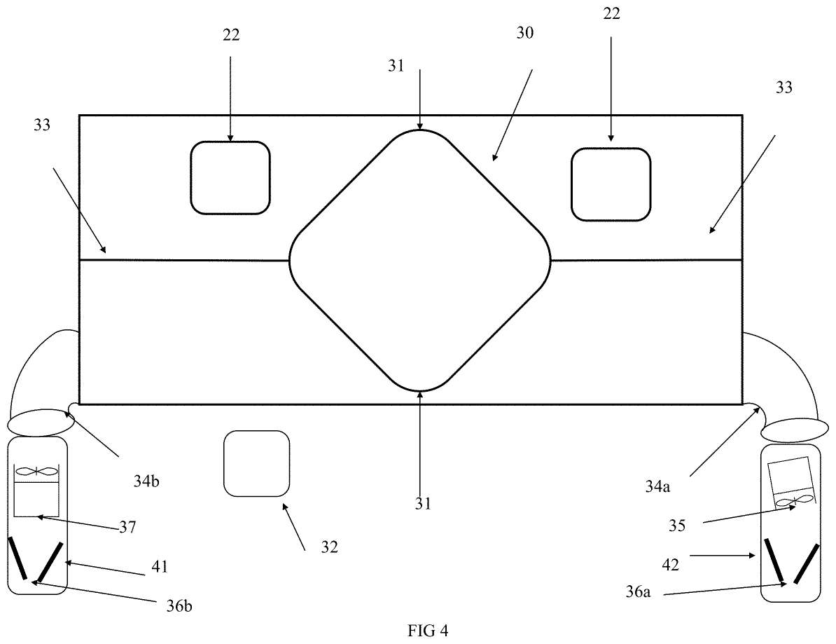

FIG. 4 is similarly a top-down view of the invention like FIG. 3, however showing some of the components optionally mounted external to the main cabinet. The same air openings shown in previous drawings 2 and 3 are depicted 22, an energy recovery core 30 affixed to side of cabinet in location 31. The invention also may have the controller 32 mounted separately outside of the main cabinet. Airflows are separated with a divider 33. External airflow connections 34a & b stub out from side of unit. The fans in this case are shown mounted external to the invention's cabinet 35 and 37 within duct or in-line which are connected to the 34a & b stub out. The airflow isolation shut-off dampers may also be mounted external to the main cabinet in attached ductwork 41 for one air path, and 42 in another airpath, containing the shutoff dampers 36b & 36a, respectively.

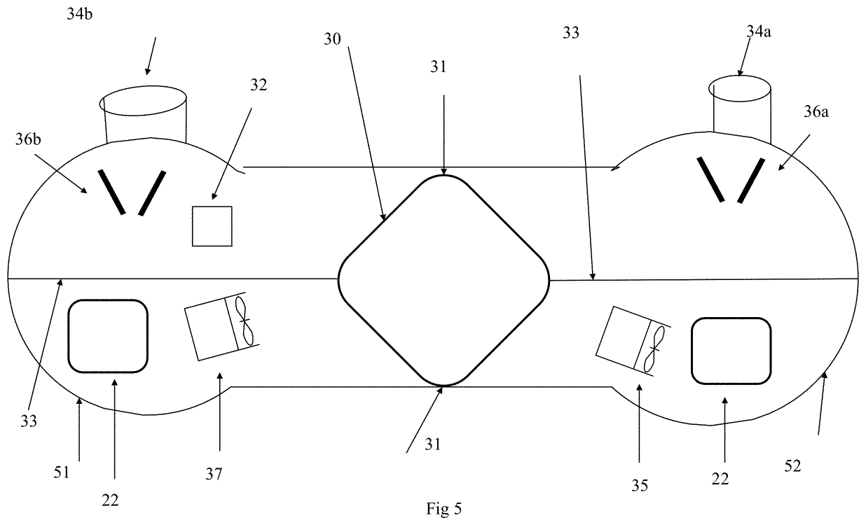

FIG. 5 depicts the invention showing many of same components introduced in FIG. 3, however assembled in a different shape housing, particularly the ends may be of a different circular shape 51 and 52. This top-down view shows the air openings 22 still on the top, and as previously shown, an energy recovery core 30 affixed to side of cabinet at location 31. The invention contains a controller 32. Airflows are separated with a divider 33. External fresh and exhaust airflow connections 34a & b stub out from side of unit. The invention may have the air movement fans 35 and 37 similarly mounted inside the invention as in FIGS. 3, and having ductwork connections 34a and 34b, and isolation air dampers 36a and 36b.

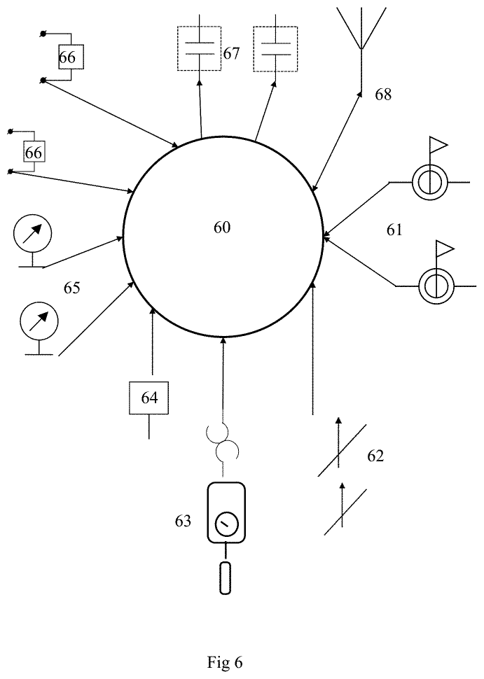

FIG. 6 is a diagrammatical representation of the components and details otherwise shown in a general controller. A central processing unit 60 having typical logic configuration and multiple analog and digital in and out signals is depicted as the center of all components and wired connections. The symbolic representation of the devices are as follows: 61 are a pair of airflow sensors, 62 are a pair of controller signals for controlling the fan speeds, 63 is a shutdown sensor measuring outside air temperature both dry bulb and wet bulb, 64 is the main power input disconnect, 65 are a pair of airflow temperature measurement devices, 66 is a pair of airflow variable pressure monitors and 67 are a pair of relays to engage each one of the fans. The controller has an antenna 68 to be Wi-Fi or Bluetooth enabled.

While the foregoing written description of the invention enables one of ordinary skill to make and use the invention in the best mode, those of ordinary skill in the art will also appreciate existence of variations, combinations and equivalents of the broad embodiment, method and examples also presented in the additional embodiments presented below. The invention should therefore not be limited by the above or below embodiments, designs, methods and examples, but should instead be interpreted to include and contemplate all the common variations that specific applications may require as modifications and additions.

In the preferred embodiment of the present invention the energy cores are minimally included in the base assembly along with the dividing airpaths allowing the preferred mode of operation where energy is exchanged from the exhausting stale indoor air to the fresh entering outdoor air, and the enclosing assembly providing a level and stabile base to support and lift an air-conditioning apparatus off the ground to a more serviceable and accessible height.

Other embodiments of the present invention provide air movement devices such as fans, air cleaning filtration, condensate drain pan, and virus and bacterial controlling ultraviolet lights and bipolar ionization. Additionally, it may include a method of defrost control for entering air, air shut off dampers for energy saving when not in use, and an integral controller to modulate and control the various devices providing the best comfort and efficiency parameters.

Additionally, the invention may be supplied as a complete enclosure with none of the air-openings shown provided at time of manufacturer. Rather, an acceptable outline of area of field-cut openings may be provided, so the air openings can be made in the field during installation to better make a custom and exact mate up to typical HVAC equipment and the installing space and system.

The present invention contemplates and provides the basis for an otherwise unobvious application and design of further incorporating energy recovery into an integrated base of the HVAC air handler such that an air handler manufacturer may make this all one assembly base incorporated into a residential, or light commercial air handling system further easing the installation and additionally otherwise providing all the benefits associated with and disclosed for this invention.

I claim:

1. An energy recovery device comprising an air housing plenum and supporting base used in an air conditioning apparatus.

2. An energy recovery device comprising:
An airtight plenum assembly, energy recovery media, and a supporting base assembly.

3. The energy recovery device as in claim 2 with said base assembly designed to match and support a traditional air-conditioning apparatus and system ductwork.

4. The energy recovery device as in claim 2 with said air-tight plenum further comprising, energy recovery media, air path openings, and a dividing structure separating airflow paths.

5. The energy recovery device as in claim 2 with said air-tight plenum further compromising individual air moving fans, filters, dampers, and the like.

6. An energy recovery device comprising:
a base assembly;
an airtight plenum;
an energy recovery section;
an outside air intake section; and
an exhaust air section.

7. An energy recovery device as in claim 6, where said base assembly supports and mates to a common air-conditioning or HVAC apparatus.

8. An energy recovery device as in claim 6, where said airtight plenum includes an air-tight dividing structure.

9. An energy recovery device as in claim 6 where said energy recovery section includes energy recovery media, mounting support and access for energy recovery media, and further comprising an opening in the airtight plenum for outside air to enter.

10. An energy recovery section as in claim 6, where said outside air intake and exhaust air sections includes air movement fans and ductwork connections and openings in the airtight plenum.
